(19) United States
(12) Patent Application Publication
(10) Pub. No.: US 2015/0095000 A1
(43) Pub. Date: Apr. 2, 2015

(54) OPTIMAL SENSOR AND ACTUATOR DEPLOYMENT FOR SYSTEM DESIGN AND CONTROL

(71) Applicant: NEC Laboratories America, Inc., Princeton, NJ (US)

(72) Inventors: Rakesh Patil, San Francisco, CA (US); Huazhen Fang, Lawrence, KS (US); Ratnesh Sharma, Fremont, CA (US)

(21) Appl. No.: 14/504,166

(22) Filed: Oct. 1, 2014

Related U.S. Application Data
(60) Provisional application No. 61/885,564, filed on Oct. 2, 2013.

(51) Int. Cl. G06F 17/50; G06F 17/11

(52) U.S. Cl. CPC G06F 17/5009; G06F 17/11
USPC 703/2

(57) ABSTRACT

A method of determining the location of actuators and sensors for climate control that includes providing a model of temperature and airflow within a room. A matrix for the placement of sensors is calculated using a Lyapunov equation. A Lyapunov equation includes a matrix for the transition state from the model of temperature and airflow. A trace of the matrix for the placement of sensors is maximized to provide optimum placement of the sensors. A matrix for the placement of actuators within the model is calculated using the Lyapunov equation. A variable for the Lyapunov equation includes the matrix for the transition state obtained from the model of temperature and airflow. A trace of the matrix for the placement of actuators is maximized to provide optimum placement of the actuators within the room.

### RELATED APPLICATION INFORMATION

This application claims priority to provisional application Ser. No. 61/885,564 filed on Oct. 2, 2013, incorporated herein by reference.

### BACKGROUND

1. Technical Field

The present invention relates to strategies for optimal placement of sensors and actuators for temperature control, and more particularly to the placement of sensors for temperature and climate measurements and the placement of air conditioning devices for a given room.

2. Description of the Related Art

Traditional sensor and actuator deployment for climate control depends almost solely on heuristic rules. Existing technology rarely deals with how to best place the sensors and actuators, but instead focuses on temperature monitoring and control with sensors and actuators having already been placed. Literature on optimal sensor and actuator placement for HVAC system design is mainly on the theoretical analysis of dynamic models comprised of partial differential equations (PDEs). From a practical view of point, these studies, due to their theoretical complexity, are too complicated for application to typical consumer applications.

Sensor and actuator placement arises in other areas besides climate control, such as sensors for vibrational control, and especially control of flexible structures. Relevant studies are also control-theory-aided. However, the solutions developed are either heuristic or rather complicated involving optimization methods, such as large-scale nonlinear integer programming. Thus computationally less expensive and easy-to-implement methods are in great need.

### SUMMARY

The present disclosure is directed to the positioning of sensors and actuators in climate control applications. In one embodiment, the method for determining the location of actuators and sensors for climate control includes providing a model of temperature and airflow within a room. The model includes a plurality of temperature and time transition states in a grid corresponding to a geometry of the room. A matrix for the placement of sensors is calculated with a processor from the model using a Lyapunov equation in which a variable for the Lyapunov equation includes a matrix for the transition state of temperature obtained from the model of temperature and airflow within the room. A trace of the matrix for the placement of sensors is maximized to provide optimum placement of the sensors within the room. A matrix for calculating the placement of actuators within the model using the Lyapunov equation is also calculated in which a variable for the Lyapunov equation includes the matrix for the transition state obtained from the model of temperature and airflow within the room. A trace of the matrix for the placement of actuators is maximized to provide optimum placement of the actuators within the room.

In another embodiment, the present disclosure provides a system for determining the location of actuators and sensors for climate control that includes a modeling module configured to provide a model of temperature and airflow within a room. The model may include a plurality of temperature and time transition states in a grid corresponding to a geometry of the room. The system further includes a sensor placement module that is configured to determine with a processor a maximized trace of an optimization problem for the placement of sensors using a Lyapunov equation. A variable for the Lyapunov equation includes a matrix for the transition state obtained from the model of temperature and airflow within the room. The maximized trace of the matrix for the placement of sensors provides optimum placement of the sensors within the room. The system may further include actuator placement module configured to determine a maximized trace of an optimization problem for the placement of actuators using the Lyapunov equation. A variable for the Lyapunov equation includes the matrix for the transition state obtained from the model of temperature and airflow within the room. The maximized trace for the placement of actuators provides optimum placement of the actuators within the room.

In another embodiment, the present disclosure provides a non-transitory computer program product comprising a computer readable storage medium having computer readable program code embodied therein for performing a method for determining the location of actuators and sensors for climate control. The method may include providing a model of temperature and airflow within a room. The model includes a plurality of temperature and time transition states in a grid corresponding to a geometry of the room. A matrix for the placement of sensors is calculated from the model using a Lyapunov equation in which a variable for the Lyapunov equation includes a matrix for the transition state of temperature obtained from the model of temperature and airflow within the room. A trace of the matrix for the placement of sensors is maximized to provide optimum placement of the sensors within the room. A matrix for calculating the placement of actuators within the model using the Lyapunov equation is also calculated in which a variable for the Lyapunov equation includes the matrix for the transition state obtained from the model of temperature and airflow within the room. A trace of the matrix for the placement of actuators is maximized to provide optimum placement of the actuators within the room.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram of a method for determining the location of actuators and sensors for climate control, in accordance with one embodiment of the present disclosure.

FIG. 2 is a block/flow diagram of a method for determining the location of actuators and sensors for climate control, in accordance with another embodiment of the present disclosure.

FIG. 3 shows an exemplary system to perform the methods for optimizing the location of actuators and sensors for climate control, in accordance with the present disclosure.

### DETAILED DESCRIPTION OF PREFERRED EMBODIMENTS

The present principles are directed to strategies for optimal placement of sensors (for temperature or climate measurements) and actuators (such as air conditioning (A/C) devices) for a given room. In some embodiments, the strategies disclosed herein optimally place sensors and actuators in a large space such that the temperature can be better monitored and regulated. The strategies can be constructed within a solid theoretical framework and have practical significance for HVAC system design with manageable computational cost.

It should be understood that embodiments described herein may be entirely hardware or may include both hardware and software elements, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc. The medium may include a non-transitory storage medium.

A data processing system suitable for storing and/or executing program code may include at least one processor, such as a hardware processor, coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

As used herein, the term “actuator” means a type of motor that is responsible for moving or controlling a mechanism of a system. The actuator is typically operated by a source of energy, such as an electric current, hydraulic fluid pressure, or pneumatic pressure, and converts that energy into motion. An actuator is the mechanism by which a control system acts upon an environment. For example, in an HVAC system, the actuator typically controls valves and dampers to control the flow of air and liquids.

As used herein, the term “sensor” means a device to measure and monitor a variable, such as temperature, pressure and humidity of ambient air. The sensors consistent for use with the present disclosure may be of electronic control or pneumatic control. Pneumatic sensors typically sense pressure. Resistance sensors, such as resistance temperature devices (RTDs), may be used for measuring temperature. Voltage sensors can be used for measuring temperature, humidity and pressure. Current sensors may be used to measure temperature, humidity and pressure.

In some embodiments, the disclosed methods, apparatus and systems provide a control-theory-based method to determine the best locations of sensors and actuators. More specifically, in some embodiments, the sensors and actuators are placed through maximizing variables related with the observability and controllability of a certain system. The problem can be solved in an analytical manner, obtaining closed-form solutions.

Compared to previous methods, the advantages provided by the approach disclosed herein are as follows: First, the solution is not only based on optimal design, but is an easily comprehendible solution for consumers, users and installers. The solutions disclosed herein are inspired by control theories and achieved via solving an optimization problem. A well-designed, but straightforward method, is established to compute the solution. Second, the speed of obtaining the solution is fast and fully manageable compared to previous approaches. In some embodiments, the most time-consuming part of the disclosed approach is solving a matrix equation, which can be handled by many numerical algorithms embedded in software. One example of a type of algorithm that is suitable for solving the matrix equation is a Lyapunov equation. In control theory, the discrete Lyapunov equation may be in the form of:

AXA^{H}−X+Q=0 Equation 1.

wherein Q is a hermitian matrix and A^{H} is the conjugate transpose of A. The continuous Lyapunov equation is of form:

AX+XA^{H}+Q=0 Equation 2.

It is noted that the above-described Lyapunov equation is only one example of an algorithm that is suitable for solving the matrix problem in accordance with the present disclosure. Other algorithms may also be suitable for use with the present disclosure.

As will be described in greater detail below, the methods, systems, and computer program product that are disclosed herein provide a computationally faster strategy for determining sensor and actuator placement when compared to previous sensor and actuator deployment strategies while retaining the rigor of the solutions. The methods disclosed herein are applicable to energy management scenarios, such as data centers and large commercial spaces, which is facilitated through the improved computational speed of the approach that is disclosed herein. The improved sensing and actuation possibilities provided by the methods, systems and computer products that are disclosed herein can lead to a reduction of energy consumption (and hence a reduction in operating costs) through efficient placement and operation of air conditioning component.

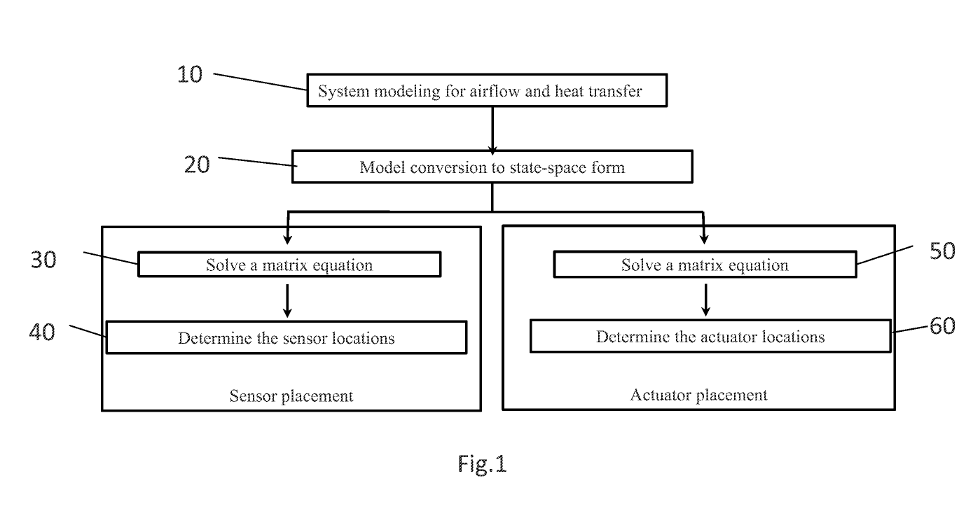

FIG. 1 depicts one embodiment of the sensor and actuator placement approach in accordance with the present disclosure. The sensor and actuator placement approach that is illustrated in FIG. 1 may be model-based. In some embodiments, at step 10 of process flow depicted in FIG. 1 models are first prepared to describe the dynamic behavior of the airflow and heat transfer in a room. The model begin with partial differential equation (PDE) based models at step 10, which are converted to the space state form at step 20.

In one embodiment, the airflow model at step 10 of the sensor and actuator placement approach that is depicted in FIG. 1 may employ a Navier-Stokes equation, which characterizes the motion of fluids. The motion of fluid can described by the equations of mass, energy and momentum balance, and this set of equations is often referred to as the Navier Stokes equations (NS). In the case of the Newtonian fluid they can be written as:

(∂ρ/∂t)+∇·(ρv)=0 (mass) Equation 3.

(∂(ρe)/∂t)+∇·(ρvh)=∇·(k∇T) (energy) Equation 4.

(∂(ρv)/∂t)+∇·(ρvvT)+∇p=∇·(μ∇v)+f (momentum) Equation 5.

where the scalars p, T, e, h, ρ, k and μ are respectively the fluid pressure, temperature, specific energy, specific enthalpy, density, thermal conductivity and dynamic viscosity; the vectors v and f are the fluid velocity and the external forces only, such as gravity, acting on the fluid.

In some embodiments, the heat transfer model at step 10 of the sensor and actuator approach that is depicted in FIG. 1 can be described by the convection-diffusion equation.

One example of a convection-diffusion equation for use with the heat transfer model may include:

$$\frac{\partial c}{\partial t} = ∇ \cdot ( D ∇ c ) - ∇ \cdot ( \vec{v } c ) + R . \qquad Equation 6$$

where c is the variable of interest (species concentration for mass transfer, temperature for heat transfer), D is the diffusivity (also called diffusion coefficient), such as mass diffusivity for particle motion or thermal diffusivity for heat transport, and \vec{v} is the average velocity that the quantity is moving. R describes “sources” or “sinks” of the quantity c. ∇ represents gradient and ∇ represents divergence. In a common situation, the diffusion coefficient is constant, there are no sources or sinks, and the velocity field describes an incompressible flow (i.e., it has zero divergence). Then the formula simplifies to:

$$\frac{\partial c}{\partial t} = D {∇}^{2} c - \vec{v } \cdot Δ c . \qquad Equation 7.$$

The following description of equations 8, 9, 10 and 11 represents one preferred embodiment of step 10 of the method depicted in FIG. 1, in which the Navier-Stokes equations for describing the conservation of momentum and mass for incompressible airflow is given, respectively, as follows:

ρ[∂V/∂t+(V·∇)V]=ρg−∇p+μ∇²V∇V=0 Equation 8

where g is the gravity vector, ∇p the pressure gradient, μ the dynamic viscosity. In this example, a steady-state airflow is assumed in this study, i.e., ∂V/∂t=0, because the model is to represent the steady-state large-scale behavior of the indoor airflow field and is intended to reduce the complexity of analysis. Consistent with this embodiment, for a time-varying temperature field T(x,y,z,t), the heat transfer via convection-diffusion is given by:

$$ρ {c}_{P} ( \frac{\partial T}{\partial t} + V \cdot ∇ T ) - ∇ \cdot ( κ ∇ T ) = h . \qquad Equation 9$$

where ρ, cₚ and κ denote, respectively, the density, specific heat and thermal conductivity of air, and h represents the heat generated or removed (‘sources’ or ‘sinks’ of T in terms of heat transfer). For equations 8 and 9, the following boundary condition is applied:

−n·V=Vb, Equation 10.

where n is the unit outward normal vector at a point on the space domain boundary, and Vb is assumed to be zero at static boundaries and non-zero at non-static ones. In some scenarios, when Vb 6 is not equal to 0, its value is known or can be determined directly from certain sensors, e.g., real-time pressure sensors. The flow of heat in the direction normal to the boundary is specified by:

−n·(k∇T)=q+αT, Equation 11.

where q results from the power of the heating or cooling sources at the boundaries and α is a coefficient.

The model obtained from step 10 includes of a set of partial differential equations (PDEs). To apply control theoretic approaches, the model composed of partial differential equations may be converted into a state-space form by applying the numerical method of lines on a uniformly gridded space in step 20 of the process flow that is described in FIG. 1. The uniformly gridded space provides a temperature and airflow distribution for a series of grid points in the model of airflow and temperature within a particular room. For example, there can be grid points at every 50 cm within a room. Each grid point within the uniformly gridded space provides a temperature variable within the room.

A state space form is a mathematical model of a physical system as a set of input, output and state variables related by first-order differential equations. Linearization, i.e., the method of lines (MOL), is finding the linear approximation to a function at a given point. The method of lines (MOL) approximates the spatial derivatives by a finite-difference-based discretization, with the resulting ordinary differential equations (ODEs) established over the time domain. For example, the MOL is applied to equation 9 along the boundary condition of equation 11 to obtain the ordinary differential equations (ODEs) and subsequently the state-space form to describe the temperature dynamics.

Considering a uniformly gridded three-dimensional space. The number of grid points along each axis is Nx, Ny, Nz, respectively. The state vector x is the collection of temperature values at all grid points, and the input vector u is a collection of the heat sources or sinks on the grid, that is

$$x ( t ) = {[ \begin{matrix}⋮ \\ T ( i , j , k , t ) \\ ⋮\end{matrix} ]}_{N \times 1} , \\ u ( t ) = [ \begin{matrix}⋮ \\ h ( i , j , k , t ) \\ ⋮\end{matrix} ] . \qquad Equation 12$$

The dimension of x is nₓ=Nx×Ny×Nz, and the dimension of u is the number of sources and sinks in the system, denoted as nᵤ. In some embodiments, n<<nₓ. The state-space equation is:

x(t)=Ax(t)+Bu(t) Equation 13.

The matrices A∈ [symbol] ⁿ^{ₓ}^{×n}^{ₓ} and B∈ [symbol] ⁿ^{ₓ}^{×n}^{ᵢ} are determined by equations 9 and 11. B indicates the placement of sources or sinks, i.e., actuators. It has a sparse binary structure—each element is 0 or 1 (after normalization), and only one element of each column can be 1 as the actuators are assumed to be point sources. That is,

B_{i,j}∈{0,1}∀i,j,Σⁿ^{ₓ}ᵢ₌₁B_{i,j}=1,2, . . . , nu. Equation 14.

The measurement vector y∈ [symbol] ⁿ^{_{y}} has a dimension equal to the number of sensors, and n_{y}<<nₓ. The output equation representing the sensor measurements are as follows:

y(t)=Cx(t), Equation 15.

where C is also a sparse binary matrix representing sensor locations with:

C_{i,j}∈{0,1}∀i,j,Σⁿ^{ₓ}ⱼ₌₁C_{i,j}=1, for i=1,2, . . . , nu. Equation 16.

Together equations 13 and 16 represent the state-space model for heat transfer in accordance with the present disclosure. It is a linear, time-invariant and high-dimensional system, as a result of the PDE reduction. In the following process flow for optimal sensor and actuator deployment, the sparse binary structure of B and C will be fully utilized to alleviate the difficulty of analysis and design. Equations 13 and 15 can be expressed together as follows:

$$\{ \begin{matrix}\dot{x} = Ax + Bu \\ y = Cx\end{matrix} , \qquad Equation 17.$$

where x represents the state of the system, e.g., temperature at grid points, u is the input to the system, e.g., cool air from the air conditioner, and y is the system output, e.g., the temperature measurements at locations where sensors are deployed. The matrix A determines the state transition. The state transition provided by matrix A describes the dynamic change in temperature in the room over time. Matrix A is provided by the model at step 10 of the process flow that is depicted in FIG. 1. Matrix A takes into account the geometry and size of the room in which the air condition is being applied, the open space, as well as the equipment that is present in the room. Matrix B is related to the positioning of the actuators within the room. For example, matrix B provides for the positioning of the source of air conditioning, e.g., cool air, within the room. Matrix C provides for the positioning of the sensors within the room for measuring the changes in temperature. Through matrix B the input excites the state, and with matrix C certain states are directly measured. For example, matrix B, i.e., related to the positioning of the actuators, provides for changes in temperature within a particular room, and matrix C, i.e., related to the positioning of the sensors, provides for the direct measurement of temperature within the room. In the above state space model, point source actuators, steady-state airflow field and negligible humidity effects have been considered. In the following process flow for optimal sensor and actuator deployment, Matrix B and C are to be mathematically found via actuator and sensor placement within the model, respectively.

For example, in one embodiment, sensor placement may be mathematically formulated using the following optimization problem, in which max_C represents the best placement, i.e., optimum placement, of the sensors within a room that is being air conditioned:

max_C trace (Wₒ) Equation 18.

The goal of the optimal sensor deployment strategy is maximizing the trace of the observability Gramian. Since the system described in equations 13, 15 and 17 is physically stable, A is a stable matrix, and the observability Gramian, Wₒ, is defined as:

Wₒ=∫₀^{∞}e^{A}^{^{T}}_{τ}C^{T}e^{At}dt, Equation 19.

where the optimal sensor locations are determined via selecting C to maximize the trace of Wₒ, as follows:

$${}_{C}^{max} tr [ {W}_{o} ( C ) ] \\ s . t . {C}_{i , j} = ∈ \{ 0 , 1 \} ∀ i , j {\sum }_{j = 1}^{{n}_{x}} {C}_{i , j} = 1 for i = 1 , 2 , … , {n}_{y} , \qquad Equation 20.$$

where C_{i,j}=1 when the sensor I is placed at the j-th point in the gridded domain and C_{i,j}=0 otherwise. The Observability Gramian is a Gramian used in optimal control theory to determine whether or not a linear system is observable, i.e., a measure for how well internal states of a system can be inferred by knowledge of its external outputs a measure for how well internal states of a system can be inferred by knowledge of its external outputs. The observability represents the ability to estimate the internal state variable using the input and output of the system. In some embodiments, its Gramian Wₒ has important implications regarding the system and state estimation. The following summarizes one interpretation of Wₒ, which may begin with determining the amount of information that the output contains about the state, because the observed energy in the output can be written as:

∥y∥²₂=∫₀^{∞}y^{T}(τ)y(dτ=x^{T}(0)Wₒx(0), Equation 21.

where x(0) is the initial state. Thereafter, the H₂ norm of the system G from equations 13 and 15 is a weighed trace of Wₒ, which can be expressed as:

∥G∥₂=tr(B^{T}WₒB), Equation 22.

The Gramian Wₒ affects the state estimation accuracy when the output is measured with noise. Taking the example, when measurements have been corrupted by additive noise vₜ, the equation becomes y(t)=Cx(t)+v(t). The least-squares estimation of x(0) given for y(t) for 0≦t≦∞ is:

x(0)=x(0)+Wₒ⁻¹∫₀^{∞}e^{A}^{^{T}}_{τ}C^{T}v(τ)dτ. Equation 23.

In some embodiments if {v(t)} is a continuous-time wide-sense-stationary (wss) Gaussian white noise process with autocovariance function Rᵥ(τ)=rδ(τ)I, then the estimation error covariance will be rWₒ⁻¹. In some embodiments, as a measure of the observability, tr(Wₒ) can be vital, because larger values correspond to an increase in the overall observability of the system. It is also related with the rank maximization of Wₒ.

A nonsingular Wₒ can guarantee complete observability. However, in some instances, Wₒ can be rank-deficient if the system is only detectable. This may happen when a limited number of sensors are deployed. In such a case it would be valuable to deploy sensors to obtain a C such that the rank of Wₒ is maximized:

max_C rank(Wₒ). Equation 24.

Solving this rank maximization problem (globally) can be difficult, and is known to be computationally non-deterministic polynomial-time hard (NP-hard). One heuristic is to replace the rank objective with the trace, in order to solve the following:

max_C tr(Wₒ) Equation 25.

Because tr(Wₒ)=Σⁿᵢ₌₁λᵢ(Wₒ), where λᵢ(Wₒ)s for i=1, 2, . . . , nₓ are the eigenvalues of Wₒ, maximizing tr(Wₒ) typically results in a high rank matrix.

The observability Gramian Wₒ is a measure of observability based on the system structure A (see e^{At}) and the state observing structure C. Using the above noted equations, the sensor placement is equivalent to finding the matrix C such that the trace of Wₒ is maximized. Such a metric is used, because Wₒ determines the amount of information that the output contains about the state and the system's robustness to measurement noise.

In accordance with some embodiments of the present disclosure, the optimization problem described above with respect to equation 13, 15, and 17 is solved analytically via a three-step procedure. First, a Lyapunov equation, +XA^{T}=−I, is solved using numeric computing software, at step 30 of the process flow illustrated in FIG. 1. X is the solution of the Lyapunov equation and A is the state matrix, and −I is the identity matrix.

Then the diagonal elements of the solution X are sorted, and the matrix C is determined, with 0 or 1 assigned to each element at step 40 of the process flow illustrated in FIG. 1. The optimization metric trace (Wₒ) can be written equivalently as trace(XC^{T}C), where X is the solution to the Lyapunov matrix. Due to the binary structure of C, C^{T}C plays the role of picking some diagonal elements of X. To maximize the considered metric, the largest diagonal elements of X are selected. More specifically, the diagonal elements of X sorted first, the large ones are found, and then the corresponding values in C are set to be 1 and the others to be 0. Further details are provided in the following description.

One computationally attractive solution to equation 20, which maximizes the tr (Wₒ) under the structural constraints of C can be developed, and written, as follows:

$$\begin{matrix}tr [ {W}_{o} ( C ) ] = tr ( {\int }_{0}^{∞} {e}^{{A}^{T}} τ {C}^{T} C {e}^{{A}_{τ}} d τ ) \\ = {\int }_{0}^{∞} tr ( {e}^{{A}^{T}} τ {C}^{T} C {e}^{{A}_{τ}} ) d τ \\ = {\int }_{0}^{∞} tr ( {e}^{{A}_{τ}} {e}^{{A}^{T}} τ {C}^{T} C ) d τ \\ = tr ( {\int }_{0}^{∞} {e}^{{A}_{τ}} {e}^{{A}^{{T}_{τ}}} d τ {C}^{T} C ) .\end{matrix} \qquad Equation 26$$

Because A is stable, X=∫₀^{∞}e^{A}^{_{τ}}e^{A}^{^{T}}_{τ}dt is the unique solution of the Lyapunov equation:

AX+XA^{T}=−I. Equation 27.

In addition, L=C^{T}C is a binary diagonal matrix. Each of its diagonal elements, L_{j,j}, is 0 or 1 for j=1, 2, . . . , nₓ; L_{j,j}=1 if a sensor is located at the j-th grid point. Therefore, to maximize tr(Wₒ)=tr(XL), only the largest diagonal elements n_{y} need to be found (sort operation), by determining the rows they belong to, and assigning 1 to the corresponding elements in C. That is, after searching through the diagonal elements of X, the set S={sₖ: k=1, 2, . . . , n_{y}} is obtained such that X_{j,j}>X_{i,i} for j∈S and I∉S; wherein C_{i,si}=1 by placing a sensor at the Si-the point for i=1, 2, . . . n_{y}.

Through this design, the sensor placement strategy maximizes an important metric closely related with system observability, helping improve the system monitoring and control performance. In addition, its implementation is fast and computationally feasible compared to previous methods.

In summation the optimal sensor deployment strategy may be summarized as follows:
Step 1: Solve AX+XA^{T}=−I
Step 2: Find the indices of the n_{y} largest diagonal elements of X and determine the index set S={sₖ: k=1, 2, . . . , n_{y}} with X_{j,j}>X_{i,I} for j∈S and I∉S;
Step 3: set the (i,sᵢ)-th element of C to 1 for I=1, 2, . . . , n_{y} and other elements to 0, or equivalently, C_{i,j}=1 if j=sᵢ and otherwise, C_{i,j}=0;
Step 4: place sensors accordingly.

A variation of the algorithm to avoid dense deployment is also developed, by introducing the constraint that each sensor effectively covers a certain area or region. One example of a constraint is that in a room of a data center some portions of the room may be occupied by the equipment within the room, such as servers. This represents a constraint, because the space occupied by the equipment can not also be occupied by a sensor or an actuator. As a result, the sensors are spatially deployed to ensure considerable observability as well as accurate temperature field reconstruction. Another consideration is that the above described optimum sensor deployment strategy is that it may yield an undesired dense or clustered sensor deployment, i.e., multiple sensors deployed within a relatively small area. Additionally, it is desirable to integrate practitioner's experience and industry guidelines into the decision process.

To overcome the above noted disadvantages, embodiments have been contemplated in which a observability map has been built that shows the distribution tr(Wₒ) over the space. The information it offers can be used with awareness of spatial limitations and inclusion of expert experience to decide sensor locations. To construct the map, a single sensor is placed at a grid point. In this case, C∈ [symbol] ^{1×n}^{ₓ}, where the element corresponding to this grid point will take 1 and the others 0. Then tr(Wₒ) is calculated to quantify the observability if a sensor is placed here. By analogy, a map illustrating the relationships between tr(Wₒ) and each spatial location can be generated. In some embodiments, the computation only relies on solving the Lypanov equation (equation 26) for X, because the diagonal elements of X are equivalents of tr(Wₒ) with a single sensor placed on the corresponding locations. To show this, an assumption is made that a sensor is placed at the i-th grid point, implying the i-th element of C is 1, i.e.,:

C=[0 . . . 0 1 0 . . . 0]_{1×n}_{ₓ} Equation 29.

Then it follows that:

tr(Wₒ)=tr(XC^{T}C)=Xᵢᵢ. Equation 30.

In general, an area in the map should be given more weight during sensor placement if it has larger tr(Wₒ). This information can be easily fused with prior experience and knowledge at the practitioners level. In view of the above, an improved optimal sensor deployment can be summarized as follows:
Step 1: Solve AX+XA^{T}=−I.
Step 2: Extract the diagonal elements of X and rearrange them with respect to the spatial locations to build the observability map.
Step 3: Decide the best locations of sensors with the aid of the map information, practitioner's experience and knowledge and industry guidelines.
Step 4: Place sensors accordingly.

The above process flow including process steps 10, 20, 30 and 40 provides for sensor placement of an HVAC system.

The actuator deployment problem is a dual of the sensor deployment problem if actuators are considered as point sources. For actuator placement, in some embodiments, the following problem is established and considered, in which max_{B} represents the best placement, i.e., optimum placement, of the actuators within a room that is being air conditioned:

max_B trace (W_{C}) Equation 30:

where the observability Gramian equation is:

Wc=∫₀^{∞}e^{At}BB^{T}e^{A}^{^{T}}_{τ}dt. Equation 31:

In the observability Gramian equation, Wc represents the controllability based on the system structure A and control structure B. The actuator placement problem is similar to the above described sensor placement problem. But, in the actuator placement problem, the actuator placement is equivalent to finding the matrix B such that the trace of W_{c} is maximized. For example,

$${}_{B}^{max} tr [ {W}_{c} ( B ) ] \\ s . t . {B}_{i , j} = ∈ \{ 0 , 1 \} ∀ i , j {\sum }_{i = 1}^{{n}_{x}} {B}_{i , j} = 1 for j = 1 , 2 , … , {n}_{u} , \qquad Equation 31$$

Equation 32 is a dual of equation of equation 24 of the optimum actuator deployment scheme. The controllability Gramian from equation 29 is chosen as the measure of control authority for a dynamic system in accordance with the present disclosure according to the following observations.

First, W_{c} is closely related with minimum energy control. Consider driving a system from x(0)=0 to x(t)= x̅ using the lowest amount of control energy:

$${min}_{u} E ( t ) \\ s . t . \dot{x} ( t ) = Ax ( t ) + Bu ( t ) , x ( 0 ) = 0 , x ( t ) = \overline{x} , \qquad Equation 32$$

where E(t)=∫₀^{t}u^{T}(τ)u(τ)dτ. The resulting control input is:

u(τ)=B^{T}e^{A}^{^{T}}_{(t-τ)}W_{c}⁻¹(t) x̅, 0≦τ≦t Equation 33:

Hence, the control energy over an infinite time horizon is E(∞)= x̅^{T}Wₒ⁻¹ x̅. Second, the H₂ norm of G is also a weighted trace of the controllability Gramian:

∥G∥₂=tr(CW_{c}C^{T}). Equation 34:

Finally, in some embodiments, a larger W_{c} can be a factor that helps suppress the influence of process noise. For example, if the input u is corrupted by an additive Gaussian white noise with a covariance Q=qI:

\dot{x}(t)=Ax(t)+B[u(t)+w(t)]. Equation 35:

Suppose the control objective is to drive the state to x̅. By optimal control theory, irrespective of how the control input u is chosen, the state x, will not be precisely achieved due to the effects of the noise w. The state covariance will be:

E[(x(∞)−x)(x(∞)−x)^{T}]=qW_{c}⁻¹, Equation 36:

which is inversely W_{c}. Thus, in some embodiments, a larger W_{c} may contribute to noise suppression. The rank of the controllability matrix is relevant to the rang of W_{c}. When a system is only stability due to the small number of actuators, the rank of the controllability matrix can be increased by placing the actuators in the best positions. Therefore, it is advantageous to solve max_{B} rank (W_{c}). Similar to equation 23, this is an NP-hard problem. The trace heuristic can hence be used to solve this problem, i.e., max_{B} tr(W_{c}).

Similar to the sensor placement problem, the optimization problem for actuator placement may be a three-step process. First, a Lyapunov equation +XA^{T}=−I, is solved using numeric computing software, at step 50 of the process flow illustrated in FIG. 1. Then the diagonal elements of the solution X from the Lyapunov equation are sorted, and the matrix B is determined, with 0 or 1 assigned to each element at step 60 of the process flow illustrated in FIG. 1. The optimization metric trace(Wc) can be written equivalently as trace (XBB^{T}), where X is the solution to the Lyapunov matrix. Due to the binary structure of B, B^{T}B indeed plays the role of picking some diagonal elements of X. To maximize the considered metric, the largest diagonal elements of X are selected. For example, the diagonal elements of X are first sorted, the large ones diagonal elements are then determined, and the corresponding values in B are set to be 1 and the others to be 0. In this way, the positions of actuators, which depend on B, are determined.

In one example, the optimal actuator deployment strategy may be summarized as follows:
Step 1: solve A^{T}X+XA=−I.
Step 2: find the indices of the ηᵤ largest diagonal elements of X and determine the index set S={s_{k:} k=1, 2, . . . , nᵤ} with X_{j,j}>X_{i,i} for j∈S and i∉ [symbol] ^{1×n}^{ₓ}S.
Step 3: set the (sⱼj)-th element of B to 1 for j=1, 2, . . . , nᵤ and other elements to 0, or equivalently, B_{i,j}=1 if i=sⱼ [symbol] ^{1×n}^{ₓ} and otherwise, B_{i,j}=0.

Through this design, the actuator placement strategy maximizes a metric closely related with system observability, helping improve the system monitoring and control performance. In addition, its implementation is fast and computationally feasible compared to previous methods. Similar to the above described optimized sensor deployment, the optimized actuator deployment may be improved by taking into account multiple decision criteria, including the controllability map, awareness of physical spatial constraints and expert experience.

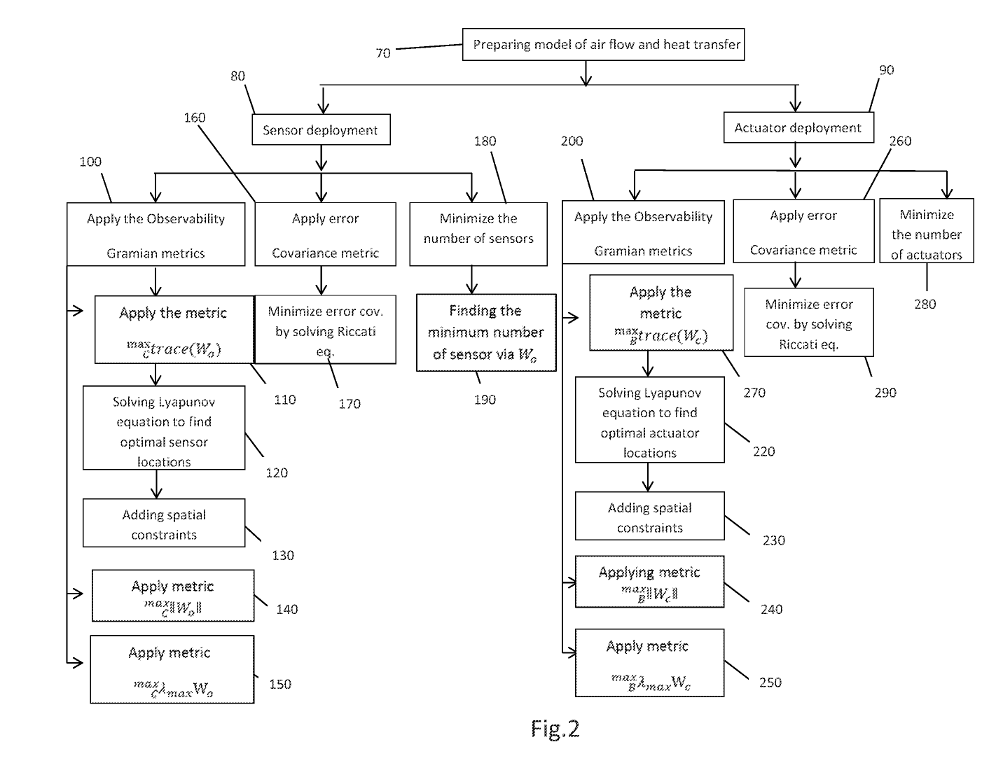

FIG. 2 depicts another embodiment of the sensor and actuator placement method and system in accordance with the present disclosure. The method of sensor and actuator placement may begin with preparing a models to describe the dynamic behavior of the airflow and heat transfer process in the room for climate control, at step 70. Step 70 of the process flow depicted in FIG. 2 has been described above with reference to steps 10 and 20 in FIG. 1. The approach leads to two strategies, one for sensor deployment 80 and the other for actuator deployment 90. The sensor deployment can be conducted using the metric of observability Gramian at step 80. In some embodiments, a meaningful metric is the trace of the Gramian to be maximized at step 110. One feature of the methods, systems and computer products disclosed herein is to transform the problem in order to obtain an analytical solution for this maximization problem. This maximization is achieved via solving a Lyapunov equation at step 120. The solution of the Lyapunov equation is used to find the optimal locations of sensors to obtain the best picture of the states in the room, therefore obtaining the most accurate temperature picture of a room. The steps employing the observability Gramian, maximized trace of the Gramian, and solving the Lyapunov equation for the sensor optimization have been described above in steps 30 and 40 of the process flow described above with reference to FIG. 1.

Referring to FIG. 2, further improvement can be made by incorporating a constraint on the spatial distribution of sensors to avoid dense deployment at step 130. For example, a constraint on the spatial distribution of sensors can include removing from the analysis the locations at which equipment is present within the room. For example, in a room of a data center, the space in the room that is occupied by servers can be removed from the analysis, because the sensors and actuators cannot occupy the same space as the physical equipment within the room.

In other cases, it might be desirable to use other metrics related to the observability Gramian matrix, such as norm eigenvalue at step 140 or maximum eigenvalue at step 150, or metrics related with the state estimation error covariance specified by an algebraic Riccati equation at steps 160 and 170 of FIG. 2. In addition, the number of sensors needed for optimum climate control, e.g., temperature and airflow, can also be determined by analyzing the observability Gramian at steps 180 and 190.

The actuator placement strategy at step 90 is a dual problem of the sensor placement. In some embodiments, the controllability Gramian at step 200 can be used in a way similar to the above discussion on the observability Gramian at step 100. For example, in some embodiments, a meaningful metric is the trace of the Gramian to be maximized at step 210. One feature of the methods, systems and computer products disclosed herein is to transform the actuator optimization problem in order to obtain an analytical solution for this maximization problem. This maximization is achieved via solving a Lyapunov equation at step 220. The solution of the Lyapunov equation is used to find the optimal locations of actuators to obtain the best picture of the states like effectuating the most efficient temperature changes as a function of time for the room. The steps employing the observability Gramian, maximized trace of the Gramian, and solving the Lyapunov equation for the actuator optimization have been described above in steps 50 and 60 of the process flow described above with reference to FIG. 1, as well as equation 10.

Similar to the strategy for sensor deployment, the strategy for actuator deployment can be modified by taking into account the spatial constraints at step 230. Other metrics can be applied to develop placement strategies for actuator in a way similar to sensor placement, such as norm eigenvalue at step 240 or maximum eigenvalue at step 250, or metrics related with the state estimation error covariance specified by an algebraic Riccati equation at steps 260 and 270. In addition, the number of actuators needed for optimum climate control, e.g., temperature and airflow, can also be determined by analyzing the observability Gramian at steps 280 and 290.

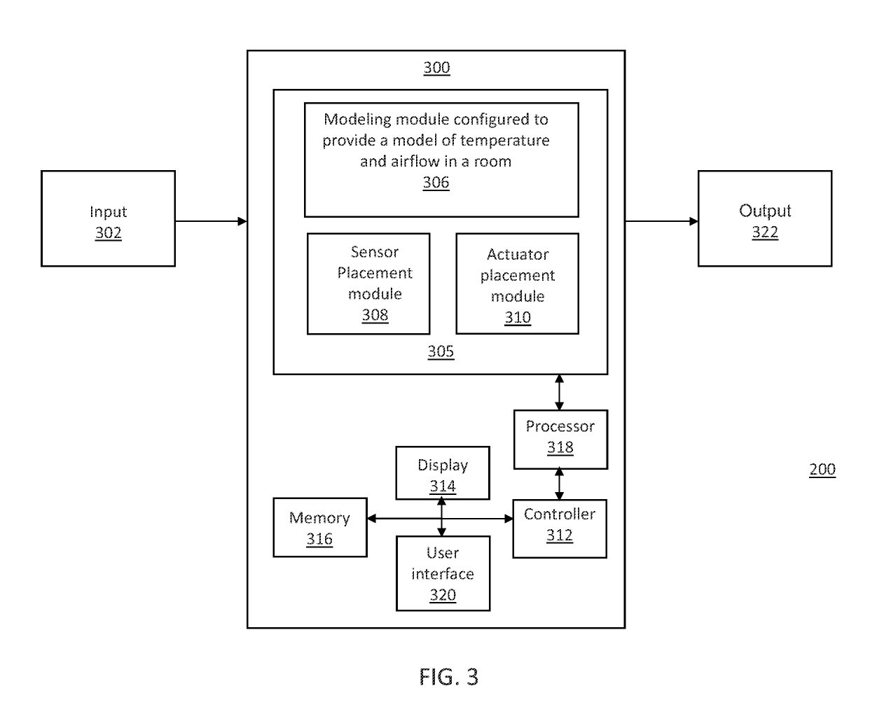

FIG. 3 depicts one embodiment of a system to perform methods for optimizing the location of actuators and sensors in climate control systems. In one embodiment, the system 300 preferably includes one or more processors 118, such as hardware processors, and memory 308, 316, such as non-transitory memory, for storing applications, modules and other data. In one example, the one or more processors 118 and memory 308, 306 may be components of a computer, in which the memory may be random access memory (RAM), a program memory (preferably a writable read-only memory (ROM) such as a flash ROM) or a combination thereof. The computer may also include an input/output (I/O) controller coupled by a CPU bus. The computer may optionally include a hard drive controller, which is coupled to a hard disk and CPU bus. Hard disk may be used for storing application programs, such as some embodiments of the present disclosure, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link.

The system 300 may include one or more displays 314 for viewing. The displays 314 may permit a user to interact with the system 300 and its components and functions. This may be further facilitated by a user interface 320, which may include a mouse, joystick, or any other peripheral or control to permit user interaction with the system 300 and/or its devices, and may be further facilitated by a controller 312. It should be understood that the components and functions of the system 300 may be integrated into one or more systems or workstations. The display 314, a keyboard and a pointing device (mouse) may also be connected to I/O bus of the computer. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

The system 300 may receive input data 302 which may be employed as input to a plurality of modules 305, including at least a modeling module 306, sensor placement module 308, and an actuator placement module 310. The system 300 may produce output data 322, which in one embodiment may be displayed on one or more display devices 314. It should be noted that while the above configuration is illustratively depicted, it is contemplated that other sorts of configurations may also be employed according to the present principles.

In one embodiment, the modeling module 306 is configured to provide a model of temperature within a room. The model that is provide by the modeling module may be calculated from equations to characterize the motion of fluids, such as a Navier-Stokes equation, and equations to provide a heat transfer model, such as the convection-diffusion equation. Further details regarding providing the model of temperature and airflow in the room have been provided above in the description of steps 10 and 20 of FIG. 1.

In one embodiment, the sensor placement module 308 is configured to provided the optimized placement of sensors for direct measurement of temperature within the room. The sensor placement module 308 can determine optimum sensor deployment using the metric of observability Gramian. For example, the metric may include a trace of the Gramian to be maximized. Additionally, maximization may be achieved via solving a Lyapunov equation. The solution of the Lyapunov equation can provide the optimal locations of the sensors to provide the best picture of the states, therefore obtaining the most accurate temperature picture of the room. Further details regarding functionality of the sensor placement module are provided in the description of steps 100, 110, 120 and 130 of FIG. 2, and steps 30 and 40 of FIG. 1 including equation 9.

In one embodiment, the actuator placement module 310 is configured to provided the optimized placement of actuators for effectuating changes in states, such as temperature and airflow, within the room. The actuator placement module 310 can determine optimum actuator deployment using the metric of observability Gramian. For example, the metric may include a trace of the Gramian to be maximized. Additionally, maximization may be achieved via solving a Lyapunov equation. The solution of the Lyapunov equation can provide the optimal locations of the sensors to provide the best picture of the states, therefore obtaining the most accurate temperature picture of the room. Further details regarding functionality of the sensor placement module are provided in the description of steps 200, 210, 220 and 230 of FIG. 2, and steps 50 and 60 of FIG. 1.

The methods, systems and computer program products disclosed herein provide analytical and closed-form solution for sensor and actuator location in climate control applications, such as HVAC. Prior technologies depend on heuristic rules to place the sensors and actuators. The strategies disclosed herein proposes an analytical solution through the use of the Lyapunov equation to maximize the trace of the observability Gramian, as described above with reference to steps 110, 120, 210 and 220 in FIG. 2. Compared to previous heuristic or approximate solutions, the strategies described herein are more rigorous and can result in improved system design, e.g., improved positioning of sensors and actuators, especially for HVAC systems.

The methods, systems and computer program products disclosed herein provide for optimized sensor and actuator location in climate control applications with relatively low computational cost. Though its development results from rigorous theoretical analysis, the strategies disclosed herein are computationally practical and can be conveniently addressed using generic scientific computing software.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. Additional information is provided in an appendix to the application entitled, “Additional Information”. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

What is claimed is:

1. A method of determining the location of actuators and sensors for climate control comprising:
providing a model of temperature and airflow within a room, wherein the model includes a plurality of temperature and time transition states in a grid corresponding to a geometry of the room;
solving an optimization problem with a processor for the placement of sensors using a Lyapunov equation in which a variable for the Lyapunov equation includes a matrix for the transition state obtained from the model of temperature and airflow within the room, wherein a maximized trace of the matrix for the placement of sensors is maximized to provide optimum placement of the sensors within the room; and
solving an optimization problem for the placement of actuators using the Lyapunov equation in which a variable for the Lyapunov equation includes the matrix for the transition state obtained from the model of temperature and airflow within the room, wherein a maximized trace of the matrix for the placement of actuators is maximized to provide optimum placement of the actuators within the room.

2. The method of claim 1, wherein the model of temperature and airflow is calculated using a first equation that characterizes the motion of fluids and a second equation for the conversion and diffusive transport of heat within the room.

3. The method of claim 2, wherein the model of temperature and airflow provided by the first equation that characterizes the motion of fluids and the second equation for the conversion and diffusive transport of heat within the room is converted to from partial differential equations to a space state form using a numerical method on lines on a uniformly gridded space.

4. The method of claim 3, wherein the space state equations for the space state form comprise:
$$\{ \begin{matrix}\dot{x} = Ax + Bu \\ y = Cx\end{matrix} ,$$
where, x represents the temperature and time transition states, u is the input to the model of the temperature and airflow within the room, y is system output of the model of temperature and the airflow within the room, matrix A determines the state transition in temperature in the room over time, matrix B is related to the positioning of the actuators within the room and excites the state transition, and matrix C provides for the positioning of the sensors within the room for measuring the changes in temperature.

5. The method of claim 4, wherein the Lyapunov equation is +XA^{T}=−I, wherein A is a matrix for determining the state transition in temperature in the room over time, I is the identity matrix, and X is the solution.

6. The method of claim 5, wherein diagonal elements of the solution from the Lyapunov equation is sorted by and a greatest diagonal element selected from the diagonal elements.

7. The method of claim 1, wherein the optimization problem for the placement of sensors comprises:
Wₒ=∫₀^{∞}e^{A}^{^{T}}_{τ}C^{T}e^{At}dt,
wherein Wₒ represents the based on a state transition A and a state observing structure C.

8. The method of claim 1, wherein the optimization problem for the placement of the actuators comprises:
Wc=∫₀^{∞}e^{At}BB^{T}e^{A}^{^{T}}_{τ}dt.
wherein Wc represents the controllability based on the system structure A and control structure B.

9. A system for determining the location of actuators and sensors for climate control comprising:
a modeling module configured to provide a model of temperature and airflow within a room, wherein the model includes a plurality of temperature and time transition states in a grid corresponding to a geometry of the room;
a sensor placement module for determining with a processor a maximized trace of an optimization problem for the placement of sensors using a Lyapunov equation in which a variable for the Lyapunov equation includes a matrix for the transition state obtained from the model of temperature and airflow within the room, wherein the maximized trace of the matrix for the placement of sensors provides optimum placement of the sensors within the room; and
an actuator placement module configured to determine a maximized trace of an optimization problem for the placement of actuators using the Lyapunov equation in which a variable for the Lyapunov equation includes the matrix for the transition state obtained from the model of temperature and airflow within the room, wherein the maximized trace for the placement of actuators provides optimum placement of the actuators within the room.

10. The system of claim 9, wherein the model of temperature and airflow is provided by a first equation that characterizes the motion of fluids and a second equation for the conversion and diffusive transport of heat within the room that is converted to from partial differential equations to a space state form using a numerical method on lines on a uniformly gridded space.

11. The system of claim 10, wherein the space state equations for the space state form comprise:
$$\{ \begin{matrix}\dot{x} = Ax + Bu \\ y = Cx\end{matrix} ,$$
where, x represents the temperature and time transition states, u is the input to the model of the temperature and airflow within the room, y is system output of the model of temperature and the airflow within the room, matrix A determines the state transition in temperature in the room over time, matrix B is related to the positioning of the actuators within the room and excites the state transition, and matrix C provides for the positioning of the sensors within the room for measuring the changes in temperature.

11. The system of claim 10, wherein the Lyapunov equation is AX+XA^{T}=−I, wherein A is a matrix for determining the state transition in temperature in the room over time, I is the identity matrix, and X is the solution.

12. The system of claim 11, wherein diagonal elements of the solution from the Lyapunov equation is sorted by and a greatest diagonal element selected from the diagonal elements.

13. The system of claim 12, wherein the optimization problem for the placement of sensors comprises:
Wₒ=∫₀^{∞}e^{A}^{^{T}}_{τ}C^{T}e^{At}dt,
wherein Wₒ represents the based on a state transition A and a state observing structure C.

14. The system of claim 12, wherein the optimization problem for the placement of the actuators comprises:
Wc=∫₀^{∞}e^{At}BB^{T}e^{A}^{^{T}}_{τ}dt.
wherein Wc represents the controllability based on the system structure A and control structure B.

15. A non-transitory computer program product comprising a computer readable storage medium having computer readable program code embodied therein for performing a method for determining the location of actuators and sensors for climate control, the method comprising:
providing a model of temperature and airflow within a room, wherein the model includes a plurality of temperature and time transition states in a grid corresponding to a geometry of the room;
solving an optimization problem for the placement of sensors using a Lyapunov equation in which a variable for the Lyapunov equation includes a matrix for the transition state obtained from the model of temperature and airflow within the room, wherein a maximized trace of the matrix for the placement of sensors is maximized to provide optimum placement of the sensors within the room; and
solving an optimization problem for the placement of actuators using the Lyapunov equation in which a variable for the Lyapunov equation includes the matrix for the transition state obtained from the model of temperature and airflow within the room, wherein a maximized trace of the matrix for the placement of actuators is maximized to provide optimum placement of the actuators within the room.

16. The computer program product of claim 15, wherein the model of temperature and airflow is provided by a first equation that characterizes the motion of fluids and a second equation for the conversion and diffusive transport of heat within the room that is converted to from partial differential equations to a space state form using a numerical method on lines on a uniformly gridded space.

17. The computer program product of claim 16, wherein the space state equations for the space state form comprise:
$$\{ \begin{matrix}\dot{x} = Ax + Bu \\ y = Cx\end{matrix} ,$$
where, x represents the temperature and time transition states, u is the input to the model of the temperature and airflow within the room, y is system output of the model of temperature and the airflow within the room, matrix A determines the state transition in temperature in the room over time, matrix B is related to the positioning of the actuators within the room and excites the state transition, and matrix C provides for the positioning of the sensors within the room for measuring the changes in temperature.

18. The computer program product of claim 17, wherein the Lyapunov equation is AX+XA^{T}=−I, wherein A is a matrix for determining the state transition in temperature in the room over time, I is the identity matrix, and X is the solution.

19. The computer program product of claim 15, wherein the optimization problem for the placement of sensors comprises:
Wₒ=∫₀^{∞}e^{A}^{^{T}}_{τ}C^{T}e^{At}dt,
wherein Wₒ represents the based on a state transition A and a state observing structure C.

20. The computer program product of claim 15, wherein the optimization problem for the placement of the actuators comprises:
Wc=∫₀^{∞}e^{At}BB^{T}e^{A}^{^{T}}_{τ}dt.
wherein We represents the controllability based on the system structure A and control structure B.
